(19) United States
(12) Patent Application Publication
(10) Pub. No.: US 2009/0100080 A1
(43) Pub. Date: Apr. 16, 2009

(54) DEVICE FOR AUTOMATIC INDEXING OF CONTENT

(76) Inventors: Yann Toms, Paris (FR); Christophe Senot, Paris (FR); Stephane Betge Brezetz, Paris (FR); Armen Aghasaryan, Savigny-Sur-Orge (FR)

Correspondence Address: FAY SHARPE/LUCENT, 1228 Euclid Avenue, 5th Floor, The Halle Building, Cleveland, OH, 44115-1843, US

(21) Appl. No.: 12/234,296

(22) Filed: Sep. 19, 2008

(30) Foreign Application Priority Data
Sep. 20, 2007 (FR) 0757700

(51) Int. Cl. G06F 17/30

(52) U.S. Cl. 707/100; 707/E17.044

(57) ABSTRACT

A device (D) is dedicated to indexing content that is made available to users. This device (D) comprises processing means (PM) tasked with associated content with metadata that defines it at least partially based on contextual information that is representative of the usage of said content by users, on user information that is representative of the profiles of the users of said content, and on metadata which had previously been associated with said content.

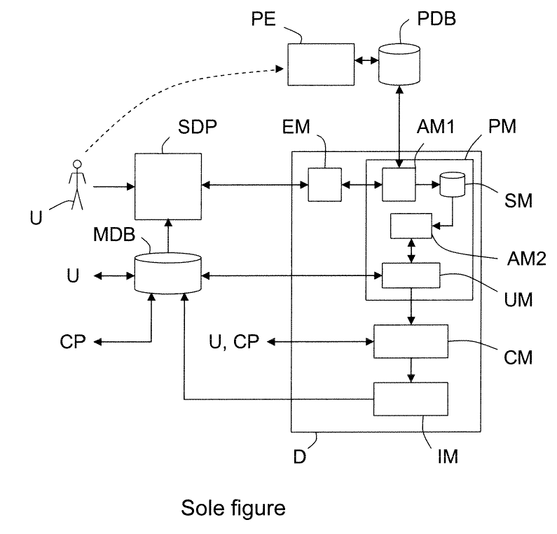

The invention pertains to the indexing of content, mainly multimedia content, intended to make said content easier to select based on the needs and/or preferences (and/or habits) of users connected to communication networks via their communication terminals.

Here, the term “content” refers to a set of data intended to be displayed on a screen and/or broadcast by loudspeakers (or their equivalents), such as, for example, television or radio programs, data, or text, image, or video files.

Furthermore, the term “communication network” here refers to any type of two-way communication infrastructure, whether wired or wireless, capable of distributing content (potentially multimedia content) to terminals, in broadcast mode and/or multicast mode and/or unicast mode. Consequently, it may be a wired network, such as an xDSL, fiber, or cable network; or a wireless network, such as a broadcasting network (such as, for example, a DVB-H terrestrial network (DBH standing for “Digital Video Broadcasting—Handhelds”, used for mobile television); or a satellite network (for example, DVB-S2 or DVB-RCS); or a hybrid network, i.e. once which is both satellite-based and terrestrial (such as, for example, a DVB-SH network (satellite links with terrestrial relays)); or a cellular (or mobile) network (such as a GSM, GPRS/EDGE, UMTS or CDMA (2000) network); or a wireless local area network (WLAN, such as, for example, WiMAX or Wi-Fi).

Finally, the term “communication terminal” here refers to any fixed or mobile (or portable or cellular) communication device capable of exchanging content with another communication terminal or network device, via a communication network. Consequently, it may, for example, be a land-line or mobile (or cellular) telephone, a laptop or desktop computer, a personal digital assistant (or PDA), a multimedia content receiver (for example, a decoder, a residential gateway, or a set-top box (STB), so long as it is equipped with two-way communication means, which may potentially be radio-based or satellite-based.

Due to the ongoing rise in the amount of content (of all types) which is made available to users (via their terminals and various media), content indexing is increasingly necessary if one desires to make it easier to select content based on users' needs and/or preferences (and/or habits).

As is known to a person skilled in the art, indexing consists of associating metadata to content in order to at least partially define and/or describe the content. As a reminder, the metadata is generally divided into three categories, known as “content” (such as, for example, the title, subject, description, genre, keywords, source, language, relationship, or cover), “intellectual property” (such as, for example, the creator, editor, contributor, or rights), and “materialization” (such as the date, type, format, or identifier).

This metadata is particularly helpful for applications that categorize, classify, or provide an optimal selection based on a user profile (namely as described in patent documents WO 2007/103938 and EP 1189437). In general, they are associated with the corresponding content by the network operators, the content providers, or the users (personal content), and are stored in a content management system (CMS).

The personal or commercial content indexing (done by creating/updating metadata) may be done manually or automatically. Manual indexing is frequently incomplete and/or subjective. Automatic indexing is currently limited and has trouble supporting scalability. It generally relies upon extracting information using audio or video analysis techniques (such as pattern recognition) which are complicated and time-consuming, and produce results that are sometimes irrelevant, or even unreliable. Furthermore, metadata which is produced automatically is fixed, and therefore cannot be changed or updated based on how the users use the content with which they are associated.

Furthermore, (very) large amounts of personal content are not indexed, particularly due to the time that this requires, and the fact that this content typically has a short lifespan.

The purpose of the invention is therefore to improve the situation of automatic indexing. It particularly pertains to the more subjective metadata of the “content” category, such as the genre, the description, and the keywords.

To that end, it discloses a device dedicated to indexing content made available to users, and comprising processing means tasked with associating content with metadata that at least partially defines it, based on contextual information representative of the use of said content by users, user information representative of the profiles of the users of that content, and metadata previously associated with that content.

The device of the invention may comprise other characteristics, which may be taken separately or in combination, in particular:
it may comprise extraction means tasked with extracting the contextual information from traces of content usage, which may, for example, be accessible within a service delivery platform;
   the traces of content usage may, for example, be chosen from among (at least) the length of time of the content usage, the time of day when the content is used, and the price paid for the usage of the content;
its processing means may comprise both first aggregation means tasked with aggregating, for each piece of content which was used by a user, contextual information which is representative of this usage of the content and user information representative of the profile of this user, in order to deliver the primary aggregated information related to this content; and second aggregation means tasked with aggregating all primary aggregated information related to a single piece of content, in order to deliver metadata related to that content;
   for each piece of content used by a user, the first aggregation means may be tasked with weighting selected user information that is representative of that user's profile against selected contextual information that is representative of that usage of the piece of content, in order to deliver primary aggregated information related to that piece of content;
   the second aggregation means may be tasked with delivering metadata related to a piece of content only when said means are capable of aggregating primary aggregated information that is related to a single piece of content and that was obtained from a number of different user profiles greater than or equal to a selected threshold;
   it may comprise storage means tasked with storing, at least temporarily, the primary aggregated information which is delivered by the first aggregation means;
   the processing means may comprise update means tasked with determining a change in the metadata previously associated with a piece of content, based on the metadata which relates to said piece of content and which was delivered by the second aggregation means;
   it may comprise control means that, whenever the processing means propose a change to the metadata previously associated with a piece of content, are tasked with determining the importance of the proposed change, and to either authorize the proposed change when its importance is low, or else to send an change authorization request message to the content provider when the importance of the proposed change is average or high, and then authorize the proposed change if an authorization message is received;
it may comprise interface means tasked with causing the storage, in metadata storage means, of metadata associated with content by the processing means.

Other characteristics and advantages of the invention shall become more apparent upon consideration of the detailed description below, and the attached drawing, in which the sole FIGURE schematically and functionally depicts one embodiment of an indexing device of the invention coupled to a service delivery platform, a metadata base and a user profile database.

The drawing may serve not only to complete the invention, but also to contribute to defining it, if need be.

The purpose of the invention is to enable automated indexing (creation/updating) of content of any type (primarily multimedia) which is made available to users (U), via communication networks of the types defined in the introductory section, and to which their communication terminals are connected.

To that end, the invention discloses an (automatic) content indexing device D comprising at least one processing module PM tasked with associated content with metadata which at least partially define it and/or describe it, based on contextual information that is representative of the use of said content by users, on user information that is representative of the profiles of the users of that content, and on metadata previously associated with that content.

Here, the term “contextual information” refers to any type of information having a direct or indirect relationship with the usage of a piece of content by a user, via a communication network to which his or her communication terminal is connected. Such information may, for example, be extracted by what a person skilled in the art would frequently call traces of content usage.

These traces of usage may include (but are not limited to):
the price paid by a user to use a piece of content. It shall be assumed that if a user watches the entirety of a piece of content whose price depends on the length of usage, the price that he paid for the usage of that content is an indicator of his or her level of satisfaction, and therefore of the quality of the match between the associated metadata and his or her profile (preferences and/or habits),
the duration of time over which a user has used a piece of content, which is, in particular, representative of the degree to which the content and the associated metadata are suitable to one another. It shall be assumed that if a user watches a piece of content to the end, that this content is a fairly good or total match for his or her profile (preferences and/or habits),
the time of day during which a user used a piece of content, such as the morning, afternoon, or evening. It shall be assumed that a piece of content can be considered more usable in the evening when it is primarily used by the users during the evening.

Such traces of content usage may, for example, be obtained by device D in a service delivery platform SDP.

It should be noted that the device D may potentially include an extraction module EM tasked with extracting contextual information selected from the traces of content usage left by the users, which are stored in a service delivery platform SDP. The contextual information may potentially be traces of usage which have been converted (formatted) by the extraction module EM so that this information can be used by the processing module PM.

Furthermore, here the term “user information” refers to any type of information that may form part of a user profile. As a reminder, a user profile is normally made up of demographic data related to that user (i.e. his or her sex, age, and place of residence or work), and/or preferences and/or that user's areas of interest (type of content, content genre, general interests, hobbies, etc.), and/or that user's usage habits. It should be noted that preferably, the profile is as extensive as possible, and is not solely made up of a preference for a type or genre of content. For example, a video viewed by users with a shared area of interest, such as home repair, may be associated with the term “home repair.”

Such user information may be obtained by the device D from a user profile database PDB, which is powered by a profile engine PE based on information provided by users or communication network operators to which said users U are subscribed.

As is depicted in the sole FIGURE, the processing module PM may include first AM1 and second AM2 aggregation modules. The first aggregation module AM1 is tasked with aggregating, for each piece of content which is used by a user U, contextual information that is representative of this usage of the content, and user information which is representative of that users profile, in order to deliver primary aggregated information related to that piece of content.

For each piece of content that has been used by a user U, the first aggregation module AM1 may, for example, be tasked with weighting selected user information representative of that users U profile against selected contextual information representative of this usage of the content, in order to deliver primary aggregated information related to that piece of content.

For example, each aggregation may be performed by weighting the values that represent the profile of a user of a piece of content with quantitative measurements of the consumption of that content by that user (such as the length of time of the usage and/or the price paid for the usage). It shall be assumed that if a user has a profile oriented towards action films, and the value “action=0.9” is assigned to him or her, then if this user has viewed a film in its entirety, there is a (very) high probability that this film is an action film.

As is depicted in the sole FIGURE, the device D, and, for example, its processing module PM, may include storage means SM which store, at least temporarily, the primary aggregated information which is delivered by the first aggregation module AM1. This at least temporary storage is intended to facilitate the scalability of the indexing. These storage means SM may be constructed in any form whatsoever, so long as they are capable of storing recorded data that each represent primary aggregated information corresponding to a content identifier. They may, for example, be a memory unit, or a database, or a file.

The second aggregation module AM2 is tasked with aggregating all the primary aggregated information related to a single piece of content, and which was determined by the first aggregation module AM1 (and may, for example, have been stored in the storage means SM), in order to deliver metadata related to that content. In other words, every time the second aggregation module AM2 intervenes, it gathers all the primary aggregated information related to a single piece of content, in order to aggregate that information into one or more pieces of metadata. This aggregation may be done in such a way that each piece of metadata corresponds to a predetermined model (or “metamodel”). For example, a piece of metadata may represent an area of interest associated with an interest value (action, 0.8) or (adventure, 0.3).

It should be noted that it is preferable, for reasons of statistical reliability, that the second aggregation module AM2 only delivers metadata related to a piece of content (and therefore only performs aggregation) if it has primary aggregated information which is related to that content and which had been obtained from a number of different user profiles greater than or equal to a selected threshold. It shall be assumed that the more primary aggregated information one has access to for a single piece of content, the more suitable the corresponding metadata will be for that content, and therefore the more reliable and/or relevant the metadata will be. For example, a threshold equal to 50, or even much greater than 50, may be chosen.

As is depicted in the sole FIGURE, the device D, and preferably its processing module PM, may also (potentially) comprise an update module UM tasked with intervening each time that the second aggregation module AM2 delivers metadata related to a piece of content. This update module UM is more precisely tasked with determining whether a piece of content, for which metadata has been determined by the processing module PM, had previously been associated with metadata, and if so, whether the metadata just determined is different from the already-existing metadata.

To do so, the update module UM may, for example, access metadata storage means MDB (or CMS for “Content Management System”), in which are stored all sets of known metadata corresponding to the associated content's identifiers. These metadata storage means MDB are generally constructed in the form of a database supplied with metadata that is manually associated with content identifiers by content providers CP and/or by users U.

If the metadata which has previously been associated with a piece of content differs from the (new) metadata which is related to that same content, and which was determined by the second aggregation module AM2, then the update module UM delivers as output this new metadata, which then constitutes a proposed change in metadata. If there is no difference, the new metadata is not delivered, because there is no need to update the corresponding previous metadata.

As is depicted in the sole FIGURE, the device D may also (and potentially) comprise a control module CM tasked with determining whether a proposed changed in metadata offered by the update module UM should or should not cause the metadata storage means MDB to be updated. Such a control module CM advantageously enables consistency in the indexing.

Every time the update module UM proposes a change in metadata which had previously been associated with a piece of content, the control module determines the importance of this proposed change. If the control module CM deems the proposed change to be of low importance, i.e. if no new proposed metadata exhibits a significant difference from previous metadata, it does not authorize an update based on that proposal. On the other hand, if the control module CM deems the proposed change to be of medium or high importance, i.e. if at least one new proposed piece of metadata exhibits a significant difference from previous metadata, it sends a change authorization request message to the content provider CP or user U that provided the content in question.

In order to determine whether a change is of low, medium, or high importance, one may, for example, compute the distance between the current metadata and the proposed metadata, and set a threshold above which the changes are to be considered important. For example, if the initial metadata established for a piece of content is “action 0.8, adventure 0.5”, and the proposed metadata is “action 0.5, comedy 0.5”, there are three differences: a first one equal to 0.3 (resulting from the difference between action 0.8 and action 0.5), a second one equal to 0.5 (resulting from the difference between adventure 0.8 and adventure 0), and a third one equal to 0.5 (resulting from the difference between comedy 0 and comedy 0.5). These three differences are then summed, which gives 1.3 (0.3+0.5+0.5=1.3), and this sum (1.3.) is compared to a threshold (for example, equal to 0.5).

If the control module CM receives no authorization message, or if it receives a message prohibiting updates within a selected period of time (a time delay), it prohibits the proposed update. On the other hand, if the control module CM receives an authorization message within the selected period of time, it authorizes the update with the proposed change.

As is depicted in the sole FIGURE, the device D may also (potentially) comprise an interface module IM tasked with causing the metadata proposed by the processing module PM to be stored within the metadata storage means MDB, potentially after the procedure for verifying that an update is beneficial and/or the control procedure. In others words, this interface module IM is tasked with updating the sets of metadata that is stored in the metadata storage means MDB, or with creating new sets of metadata within these storage means MDB.

Once the metadata describing the content has been obtained in accordance with the invention, a multitude of applications making use of their informative content may be foreseen. In this manner, one may recommend content based on a user profile, or search for content by keywords, or run a personalized search based on the user profile.

The indexing device D of the invention, and in particular its processing module PM and, if any, its extraction module EM, control module CM, and interface module IM, may be constructed in the form of electronic circuits, software (or computing) modules, or a combination of circuits and software.

By offering automatic content indexing that is more relevant, specific, and reliable, for a much larger amount of content (including personal content), the invention enables communication network operators and service or content providers to offer their clients better services.

The invention is not limited to the embodiments of the indexing device described above, which are only given by way of example; rather, it encompasses all variants that a person skilled in the art may envision within the framework of the claims below.

1. A device (D) for indexing content made available to users, characterized in that said device comprises processing means (PM) configured to associated content with metadata that at least partially defines it based on contextual information representative of the usage of said content by users; on user information representative of the profiles of the users of said content; and on metadata previously associated with said content.

2. A device according to claim 1, characterized in that it comprises extraction means (EM) configured to extract said contextual information from traces of content usage accessible within a service delivery platform (SDP).

3. A device according to claim 2, characterized in that said traces of content usage are chosen from among a group comprising at least the duration of length of time of the usage of said content, the time of day when said content was used, and the price paid for the usage of said content.

4. A device according to claim 1, characterized in that said processing means (PM) comprise i) first aggregation means (AM1) configured to aggregate, for each piece of content used by a user, contextual information representative of this content usage and user information representative of that user's profile, so as to deliver primary aggregated information related to said content, and ii) second aggregation means (AM2) configured to aggregate all primary aggregated information related to a single piece of content, so as to deliver metadata related to said content.

5. A device according to claim 4, characterized in that said first aggregation means (AM1) are configured to weight, for each piece of content used by a user, selected user information, representative of that user's profile, against selected contextual information, representative of this content usage, so as to deliver primary aggregated information related to said content.

6. A device according to claim 4, characterized in that said second aggregation means (AM2) are configured to deliver metadata related to a piece of content whenever they are capable of aggregating primary aggregated information that is related to a single piece of content and that is obtained from a number of different user profiles greater than or equal to a selected threshold.

7. A device according to claim 4, characterized in that it comprises storage means (SM) configured to at least temporarily store said primary aggregated information delivered by said first aggregation means (AM1).

8. A device according to claim 4, characterized in that said processing means (PM) comprise update means configured to determine a change in metadata previously associated with a piece of content based on said metadata related to this content and delivered by said second aggregation means (AM2).

9. A device according to claim 4, characterized in that it comprises control means (CM) configures, whenever said processing means (PM) propose a change in the metadata previously associated with a piece of content, to determine the importance of said proposed change, and either to authorize said proposed change when its importance is low, or to send a change authorization request message to the provider of said content whenever the importance of the proposed change is medium or high, in order to authorize said proposed change in the event that an authorization message is received.

10. A device according to claim 1, characterized in that it comprises interface means (IM) configured to cause the metadata associated with said content by said processing means PM to be stored within the metadata storage means (MDB).
